(19) United States
(12) Patent Application Publication
(10) Pub. No.: US 2006/0103838 A1
(43) Pub. Date: May 18, 2006

(54) Method for inspecting a wafer

(75) Inventors: Joerg Richter, Gladenbach-Weidenhausen (DE); Detlef Michelsson, Wetzlar-Naunheim (DE)

Correspondence Address: HOUSTON ELISEEVA, 4 MILITIA DRIVE, SUITE 4, LEXINGTON, MA, 02421, US

(73) Assignee: Leica Microsystems Semiconductor GmbH, Wetzlar (DE)

(21) Appl. No.: 11/254,024

(22) Filed: Oct. 19, 2005

(30) Foreign Application Priority Data
Nov. 16, 2004 (DE) 10 2004 055 250.9

(51) Int. Cl. G01N 21/88

(52) U.S. Cl. 356/237.5

(57) ABSTRACT

The examination of a wafer (10) has until now been implemented by means of wafer-to-wafer comparison of the entire wafer (10). In order to ensure timely detection of defects, or the development of defects, on a wafer (10) wafer-to-wafer comparison is limited to particular comparison regions (22) selected by the user.

### RELATED APPLICATIONS

This application claims priority to German patent application number DE 10 2004 055 250.9, filed Nov. 16, 2004, which is incorporated herein by reference in its entirety.

### BACKGROUND OF THE INVENTION

The invention relates to a method for inspecting a wafer, in particular for detecting macroscopic defects.

### SUMMARY OF THE INVENTION

In semiconductor processing, wafers are sequentially processed in a multiplicity of processing steps, whereby a multiplicity of identical recurrent structural elements, so-called dies, are produced on a wafer. With increasing integration density, the quality requirements increase for the structures formed on the wafer. In order to monitor the quality of the formed structures, and to identify defects that may occur, the quality, precision, and reproducibility requirements for the components and processing steps used in manipulating the wafers are correspondingly high. This means that reliable and timely detection of defects in the individual structures is of particular importance in the production of a wafer with a multiplicity of processing steps and a multiplicity of applied photoresist or other similar layers.

It is advantageous to test the achieved quality after implementation of a processing step. This makes it possible, for example, to evaluate reliably the quality achieved after lithography during the production process and before any subsequent processing step. This means that one can determine whether a wafer or structures formed on a wafer are defective right after implementation of a given processing step and prior to completion of the production process so that the wafer can be immediately rejected without having to implement subsequent processing steps. Similarly, a wafer that has been found to be defective can be processed separately until adequate quality is achieved. This results in increased efficiency and output in semiconductor processing.

Optical defect recognition involves taking account of systematic errors caused by fluctuations in the thickness of the coating on a semiconductor wafer in order to avoid marking locations on the semiconductor wafer that contain no defects.

Optical devices are particularly suitable for inspecting the surface of wafers. As it is known from EP 455 857, examination of the surface can, for example, be implemented by analyzing beams that are reflected back from the surface of the wafer.

In order to detect macroscopic defects on semiconductor wafers, the dies on one and the same wafer are compared using the so-called die-to-die method. Highly uniform structures are formed on the wafer using extremely precise processes. Images that are taken of the dies are identical when there are no process defects that might have a negative effect on the formation of the dies. Any differences between two images can thus be interpreted as a defect. Such a method is described, for example, in US 2004/0105578 A1. Such a comparison can, however, only be implemented in regions of the wafer that exhibit the same dies. For this reason, this method is suitable only for regions with so-called productive dies. Other regions of the wafer, which, for example, exhibits test fields, regions without structures, or that are located at the edge of the wafer, can not be examined in this manner. It has been shown that important information may be gained from such regions as well, which contributes or makes possible timely recognition of defects. As a result, problems that occur during application of the coating, particularly at the edge of the wafer, can be recognized early because they appear here first and then continue in the direction of the middle over the course of production. These defects cannot be recognized if these regions are not examined. As a result, defects crop up later on the completed dies, making the wafer potentially unusable.

A wafer-to-wafer comparison in which a wafer is compared completely with a second subsequently produced wafer in a so-called one-shot method could be helpful. However, this method requires that very large quantities of data be compared, which leads to a significant reduction in the speed of the test. In contrast to die-to-die comparison, this method is not independent of machine tolerances, which can make themselves felt in the production of two successive wafers.

The object of the present invention is therefore to propose a method by which defects that occur can be detected as early as possible.

This task is solved by a method according to the invention for inspecting a wafer, having the characteristics set forth in claim 1.

This invention proposes a method for detecting macroscopic defects on a semiconductor wafer, whereby only certain regions of the wafer are selected for comparative purposes rather than the wafer-to-wafer comparison that has been conducted until now, in which the entire wafer is taken into account in the comparison. The comparison is subsequently limited to these selected regions via a user interface, with which the user first defines a selected region, from which a comparison region, particularly one in the form of a rectangle, is then defined automatically or manually. The comparison region is thus a partial section of the previously defined region that was selected. This significantly reduces the quantity of data required to implement the comparison. By skillfully defining the selected region, a person skilled in the art can use such regions of which it is known that the defects first become noticeable there for the purpose of comparison. This typically involves the edge regions of coated wafers. As a result, production defects can be recognized early, making it possible to intervene quickly in the production process.

Preferably, defining the selected region is done in a so-called learning mode in which the selected region is determined for all further comparisons. The comparison region, which comprises a section of the selection region can then be defined either automatically, or manually in the learning mode. For this purpose, it is preferable to define a comparison region that contain no dies produce by the process. This is because the productive dies are identical structural elements that are to be produced without defects in the production process, and are therefore arranged at a defined distance to the edge of the wafer.

Individual elements such as wafer identification codes or barcodes are often provided on the wafers and are located within the selected comparison regions. These are then excluded in a so-called exclude region so that the wafer-to-wafer comparison can still be implemented.

While the non-productive regions can be inspected in a wafer-to-wafer comparison with the help of this method, evaluation of the productive dies can be implemented in a die-to-die comparison. This may be implemented simultaneously or sequentially.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

Shown in detail:

FIG. 1 Schematic of a wafer with a selection region and comparison region divisions

FIG. 2 Schematic of the sequence of the method according to the invention.

### DETAILED DESCRIPTION OF THE PREFERRED EMBODIMENTS

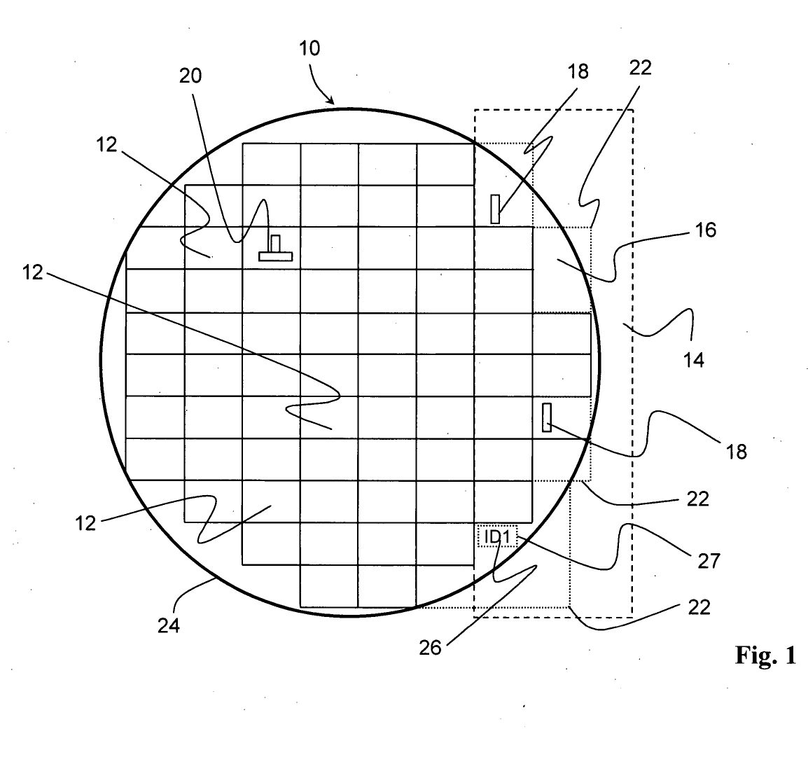

FIG. 1 shows a schematic of a wafer 10 on which a multiplicity of identical structures, the so-called dies 12, have been applied. In the usual die-to-die comparison, these dies 12 are compared with each other, and any differences found between the dies 12 are recognized as defects.

To be able to define an early indicator of changing processing conditions or contrasting defects, the comparison is expanded to include non-productive regions. However, wafer-to-wafer comparisons must be conducted for this purpose. In order to keep the quantity of data as low as possible for the comparison, a learning mode is preferred in which the user selects a suitable selection region 14. This selection region 14 is preferably rectangular and comprises the edge region of the wafer 10. Both productive dies 12 and non-productive regions 16 may be located in this selection region 14. In the non-productive regions 16 test structures 18 are provided, whose defect-free production can be monitored by means of wafer-to-wafer comparison. Alternatively or cumulatively, test structures 20 may also be provided in the middle of the wafer 10. In so far as these test structures 20 are provided only singly on the wafer 10, this test structure 20 can be monitored only by wafer-to-wafer comparison.

After defining the selection region 14 by a user via a user interface, one or several comparison regions 22 are defined in a learning phase, preferably in the form of rectangles. These can be either automatically or manually defined by the user. The wafer-to-wafer comparison is then implemented in these comparison regions 22.

In addition, the user may also define individual test structures 20 that are provided in the productive regions of the wafer 10.

The entire usable surface of the wafer 10, which is limited by the edge 24 of the wafer, can be used when implementing wafer-to-wafer comparison; however, it remains limited to the comparison regions 24 and/or test structures 20. In so far as an individual marking 26 is provided for each wafer in a comparison region 22, this marking 26, as an exclude region 27, will not be taken into account in the wafer-to-wafer comparison. Individual markings 26 may include a wafer identification code, barcode, or similar markings. The exclude regions 27 provided in this manner may overlap the comparison regions in any arbitrary way.

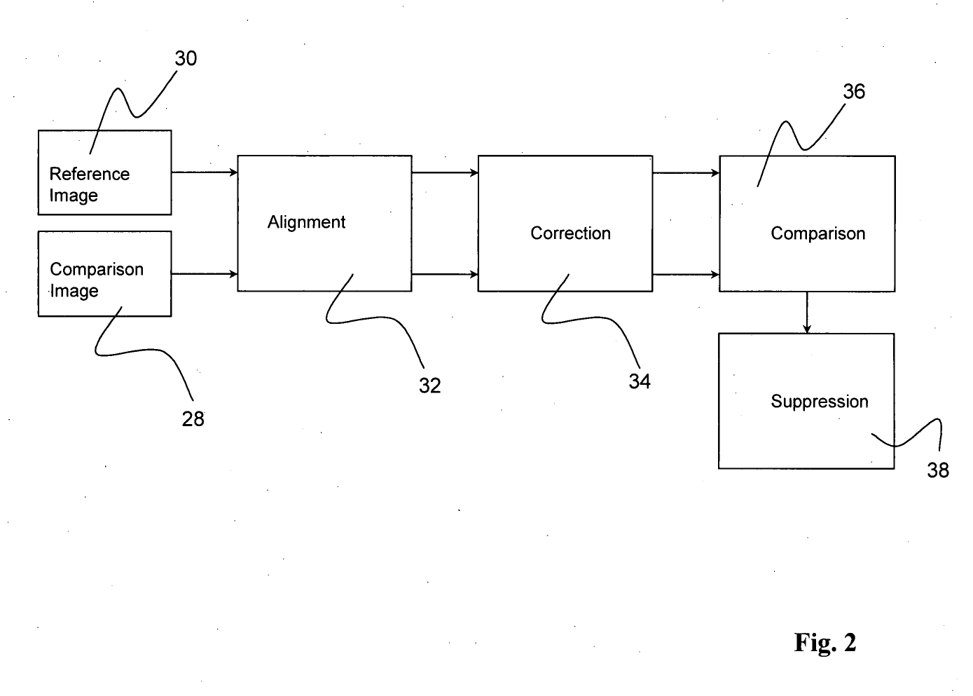

The sequence of the method in the learning mode is depicted schematically in FIG. 2. A comparison region 22 is selected on the surface of the wafer 10, and a comparison image 28 is created from this comparison region 22. This comparison image 28 is compared with a reference image 30 by means of the wafer-to-wafer comparison method. For this purpose, the reference image 30 and the comparison image 28 are first aligned with each other in an alignment process 32. This may, for example, be implemented such that the reference image 30 is aligned with the comparison image 28 by rotation, translation and/or scaling such that both images are precisely aligned with and overlap each other. An illumination correction 34 is then done such that the brightness of the images to be compared 28, 30 are standardized so that any changes in illumination can be equalized, i.e., calculated for.

The images undergo comparison 36 after the images are standardized. For this purpose, an additional parameter that establishes the detection sensitivity of the comparison region 22 can be used to determine which deviation derived from the image-to-image comparison between the reference image 30 and the comparison image 28 represents a defect. In this way the number and position of the defects resulting from the image comparison become known.

A suppression step 38 then removes or suppresses any of the resultant defects that occur in invalid regions of the comparison region 22. These invalid regions may, for example, be the result of exclude regions 27, or they may result from regions that lie outside the edge 24 of the wafer 10 and are therefore outside the usable surface of the wafer 10. As a result, production-related changes in the comparison regions 22 can be detected by means of the wafer-to-wafer comparison. The actual defects that have been confirmed can then be fed into a further defect analysis process to determine the type of defect and possible changes needed in the process parameters that might counter the development of these defects.

As already described, the comparison region 22 may also lie within the productive surface of the wafer 10. For example, the middle portion of the wafer 10 may be provided with a test structure 20 (FIG. 1) that is present singly on each wafer. The test structure 20 is produced on each wafer during the production process and is therefore available for wafer-to-wafer comparison. It has been shown to be advantageous when implementing this comparison to have lower sensitivity in the image-to-image comparison. This is because the fluctuations that result from the production process would otherwise lead to differences in the comparison of the images that might be interpreted as defects when there are none in actuality.

Reference images 30 are required for the wafer-to-wafer comparison as described. In principle, these may be created by any means that permit reliable comparison of images. In particular, the reference images 30 may be created from an established learning image from which is derived the data for the reference image 30. The corresponding comparison region 22 of a previous wafer, particularly the most immediately previous wafer, can be used as the reference image. A so-called “golden image” can be used as the reference image to better take account of small insignificant deviations in the production process. This golden image is created by generating a variance image containing negligible deviations from each of the corresponding comparison regions 22 of different wafers 10.

Using the procedure described it is now possible to implement a wafer-to-wafer comparison that still permits one to work with a reduced quantity of data, which makes faster image comparison possible. Furthermore, defects that crop up initially, particularly at the edge region, can be detected early and taken into account over the course of production. With the help of the exclude region 27, the method can also be implemented if data or individual markings 26 on the wafer 10 are provided that are unique to each wafer 10.

Naturally, the proposed method can also be combined with a die-to-die method and therefore be implemented simultaneously or sequentially with it.

### REFERENCE LIST

10—Wafer; 12—Die; 14—Selection region; 16—Non-productive region; 18—Test structure in the non-productive region; 20—Test structure in the middle of the wafer; 22—Comparison region; 24—Edge of the wafer; 26—Individual marking; 27—Exclude region; 28—Comparison image; 30—Reference image; 32—Aligning process; 34—Illumination correction; 36—Comparison; 38—Suppression.

While this invention has been particularly shown and described with references to preferred embodiments thereof, it will be understood by those skilled in the art that various changes in form and details may be made therein without departing from the scope of the invention encompassed by the appended claims.

What is claimed is:

1. Method for inspecting a wafer comprises the steps of:
detecting macroscopic defects, selecting a comparison region on the wafer generating a comparison image from this comparison region and comparing the comparison region with a reference region.

2. Method for inspecting a wafer according to claim 1, wherein a selection region is selected via a user interface, and then the comparison region is established automatically or manually from this selection region as a partial region.

3. Method for inspecting a wafer according to claim 2, wherein the selection region is selected in a learning mode.

4. Method for inspecting a wafer according to claim 1, wherein the comparison region has a basic geometric form, in particular a rectangular form.

5. Method for inspecting a wafer according to claim 1, wherein the comparison region is selected such that it comprises the edge of the wafer.

6. Method for inspecting a wafer according to claim 1, wherein the comparison region is selected such that it exhibits individual markings for it each wafer, which are excluded from comparison, in particular by a so-called exclude region.

7. Method for inspecting a wafer according to claim 6, wherein the exclude regions may have any geometric form.

8. Method for inspecting a wafer according to claim 7, wherein the geometric form is a rectangle.

9. Method for inspecting a wafer according to claim 1, wherein a plurality of dies provided on the wafer are compared by means of die-to-die comparison.
